(19) United States
(12) Patent Application Publication
(10) Pub. No.: US 2007/0185265 A1
(43) Pub. Date: Aug. 9, 2007

(54) Impact-modified blends

(75) Inventors: Marina Rogunova, Pittsburgh, PA (US); Roger W. Avakian, Aurora, OH (US); Alban Wurtz, Gaggenau (DE); Diana Weidner, Karlsruhe (DE)

Correspondence Address: POLYONE CORPORATION, 33587 WALKER ROAD, AVON LAKE, OH, 44012, US

(73) Assignee: POLYONE CORPORATION, Avon Lake, OH (US)

(21) Appl. No.: 10/598,319

(22) PCT Filed: Feb. 22, 2005
(86) PCT No.: PCT/US05/05559

§ 371 Date: Aug. 24, 2006

Related U.S. Application Data
(60) Provisional application No. 60/548,069, filed on Feb. 25, 2004.

(51) Int. Cl. C08L 53/00; B32B 27/38; B32B 27/00

(52) U.S. Cl. 525/88; 525/92 D

(57) ABSTRACT

A tri-block copolymer is disclosed for use in thermoplastic blends of polyamide and polyphenylene ether, preferably also including polystyrene. The tri-block copolymer comprises an aromatic block, an olefin midblock, and an alkyl (meth)acrylate block.

### CLAIM OF PRIORITY

This application claims priority from U.S. Provisional Patent Application Ser. No. 60/548,069 bearing Attorney Docket Number 1200404 and filed on Feb. 25, 2004.

### FIELD OF THE INVENTION

This invention relates the use of a tri-block copolymer as an impact modifier alone in blends of polyamide and polyphenylene ether/polystyrene.

### BACKGROUND OF THE INVENTION

Blends of polyamide (PA) and polystyrene (PS) have been commercially available from PolyOne Th. Bergmann GmbH of Gaggenau, Germany.

The market continually seeks better engineered thermoplastics.

One technology is disclosed in U.S. Pat. No. 5,719,233 (Gallucci et al.) wherein a blend of PA and polyphenylene ether (PPE) is further blended with a compatibilizer and modifier resin selected from the group consisting of vinyl aromatic hydrogenated conjugated diene block copolymers, vinyl aromatic partially hydrogenated conjugated diene block copolymers, and vinyl aromatic non-hydrogenated conjugated diene triblock copolymers.

### SUMMARY OF THE INVENTION

What is needed is better impact modification for blends of polyamide and polyphenylene ether/polystyrene. There is a need to produce blends which have good impact properties, smooth surface finishes, weatherability, scratch resistance, solvent resistance, and a balance of tensile and impact properties.

The present invention provides use of a new impact modifier that enhances impact properties throughout service temperatures (−40° C. -70° C.) for blends, particularly PA-PPE/PS blends without compromising tensile properties. The new impact modifier can be used alone, or optionally in combination with the styrenic block copolymer impact modifiers.

The new impact modifier is a triblock copolymer of a hard-soft-hard configuration, which permits it to respond to both low and high temperature conditions with good impact properties.

One aspect of the present invention is a thermoplastic polymer blend, comprising (a) a polyamide; (b) a polyphenylene ether; and (c) a tri-block copolymer of an aromatic monomer, an olefin monomer, and an alkyl (meth)acrylate monomer, and (d) a compatibilizing polymer containing a dicarboxylic acid anhydride functionality.

An advantage of the blends of the present invention is good impact properties at room temperature without compromising other physical properties otherwise present, e.g., tensile strength.

Other features and advantages will be revealed in the discussion of the embodiments below with reference to the following drawings.

Embodiments of the Invention

Thermoplastic Polymers to be Impact Modified

The thermoplastic polymers can be polyamides (PA), polyphenylene ethers (PPE) alone or in combination with polystyrene (PS), or blends thereof.

Of polyamides, polyamide 6, polyamide 6,6, polyamide 4,6, polyamide 11, polyamide 12, and nanoclay-dispersed polyamides are possible resins for the matrix of the blend of the invention, with polyamide 6,6 being preferred for use in the invention. In the case of nanoclay-dispersed polyamide 6, the nanoclay is dispersed into the monomers prior to polymerization of the polyamide according to the technique disclosed in U.S. Pat. No. 4,739,007. Alternatively, the nanoclay and the polyamide can be melt mixed. Polyamide 6,6 is commercially available from a number of sources, including Rhodia. The relative contribution of the polyamide to the total blend ranges from about 30 to about 50 weight percent, and preferably from about 40 to about 45 weight percent.

Of PPE for dispersed regions in the PA matrix, PPO® brand polyphenylene ether is preferred and is commercially available from GE Plastics of the General Electric Company. More preferably, PPE is blended with polystyrene, preferably high-impact polystyrene (HIPS). PPE/HIPS is commercially available as NORYL® brand engineering thermoplastic resins also from GE Plastics.

PPE, a high-heat amorphous polymer, forms a miscible, single-phase blend with PS. This technology, in combination with other additives, provides a family of resins covering a wide range of physical and thermomechanical properties. General characteristics include high heat resistance, excellent electrical properties, hydrolytic stability, dimensional stability, low mold shrinkage and very low creep behavior at elevated temperatures. Other information about PPE/PS blends can be found at www.geplastics.com. The relative contribution of the PPE/PS blend to the total blend ranges from about 30 to about 50 weight percent, and preferably from about 35 to about 45 weight percent.

A blend of PA and PPE/HIPS can be used in injection molding, extrusion, blow molding, and structural foam molding.

Compatibilizing Polymer

Another polymer in the blend of the present invention serves to strengthen the interface between the dispersed domains of PPE/PS and the continuous matrix of PA. That compatibilizing polymer is a polymer containing a dicarboxylic acid anhydride functionality, preferably a fumaric acid modified-polyphenylene ether. This compatibilizing polymer reacts at its functionality group (whether anhydride or acid functionality) with PA to form covalent bonds to the matrix while affiliating its non-functional regions with PPE/PS otherwise. A commercially source of fumaric acid modified PPE is DH Compounding of Clinton, TN, USA.

Other compatibilizing polymers are disclosed in U.S. Pat. No. 5,719,233 (Gallucci et al.). In this situation, the compatibilizing polymer is formed in-situ by use of a compatibilizer reacting with some of the PPE.

Briefly, Gallucci et al. disclose a compatibilizer consisting of one or more aliphatic polycarboxylic acids or derivatives thereof represented by the formula:
(R^{I}O)ₘR(COOR^{II})ₙ(CONR^{III}R^{IV})ₛ
wherein R is a linear or branched chain, saturated aliphatic hydrocarbon of from 2 to 20 carbon atoms; R^{I} is selected from the group consisting of hydrogen, and alkyl, aryl, acyl and carbonyl dioxy groups having from 1 to 10 carbon atoms; each R^{II} is independently selected from the group consisting of hydrogen, and alkyl or aryl groups having from 1 to 20 carbon atoms; each R^{III} and R^{IV} is independently selected from the group consisting of hydrogen, and alkyl or aryl groups having from 1 to 10 carbon atoms; m is equal to 1 and (n+s) is greater than or equal to 2, and n and s are each greater than or equal to 0; wherein (OR^{I},) is alpha or beta to a carbonyl group and at least 2 carbonyl groups are separated by 2 to 6 carbon atoms.

Among the compatibilizers, unsaturated anhydrides such as maleic anhydride are preferred. Alternatively, precursors of anhydrides, such as itaconic acid or citric acid, can be used, which form itaconic anhydride and citraconic anhydride, respectively, upon decomposition.

Additionally, other compatibilizers are envisioned, such as functional silanes or quinones.

Such functional PPE can be included in the blend of the present invention in an amount from 0 to about 5, and preferably from about 3 weight percent of the blend, whether added in the functionalized polymeric form or made in-situ according to the disclosure of Gallucci et al. To achieve that concentration of functional PPE, Gallucci et al. teach the use of about 4%, preferably from about 0.05 to about 4%, most preferably from about 0.1 to about 2% by weight, based on the total composition, of polycarboxylic acid compatibilizer.

Triblock Copolymer Impact Modifier

Departing from the prior art, the blends of the present invention contain a new impact modifier, tri-block copolymers constructed of three linear chains covalently bonded to one another. The three blocks are an aromatic block, an olefin block, and an alkyl (meth)acrylate block.

The relative contribution of the aromatic block to the tri-block copolymer ranges from about 20 to about 55, and preferably from about 33 to about 46 weight percent of the copolymer.

The aromatic block can affiliate with PS, PPE, or both in the PPE/PS polymer regions dispersed in the PA matrix. Thus, impact modification occurs neatly within the dispersed PPE/PS phase of the blend only.

Non-limiting examples of the olefin monomer are alkyl monomers having four carbon atoms: butylene, and butadiene. Butadiene is preferred because of its low glass transition temperature (−85° C.), its heat stability, and its better affinity with fillers such as carbon black.

The relative contribution of the olefin block to the tri-block copolymer ranges from about 7 to about 40, and preferably from about 14 to about 33 weight percent.

Non-limiting examples of the alkyl (meth)acrylate monomer include tert-butylmethacrylate and methylmethacrylate, with mostly syndiotactic methylmethacrylate being preferred due to a high glass transition temperature (135° C.), better miscibility with some polymers such as PC and PVC, and increased heat stability.

The relative contribution of the alkyl (meth)acrylate block to the tri-block copolymer ranges from about 20 to about 55, and preferably from about 20 to about 33 weight percent.

Such tri-block copolymers are commercially available such as the styrene-butadiene-methylmethacrylate family of products commercially available as “SBM” from Atofina Chemicals, Inc. of Philadelphia, Pa.

Such tri-block copolymer impact modifier can be included in the blend of the present invention in an amount from about 3 to about 25, and preferably from about 5 to about 15 weight percent of the blend. Most preferably, the amount is about 10 weight percent of the blend.

Not being limited to a particular theory, one advantage of using SBM tri-block copolymer as an impact modifier is that the copolymer provides nano-structuralization in the polymer matrix to better absorb energy during impact.

While not being limited to a particular theory, it is believed that the alkyl (meth)acrylate block (which is hydrophilic) of the tri-block copolymer are conformed together away from the PPE/PS (which are hydrophobic). Therefore, as the impact modifier conforms within the dispersed phase of the blend, the hydrophilic region of the alkyl (meth)acrylate block of the tri-block copolymer curls around itself, followed by a wrapping of the elastic olefin block, followed by a wrapping of the aromatic block. The immiscibility of each of the blocks with each of the other two means that this wrapping occurs without interruption or intermixing. The result is a simulation of a core-shell particle (also called in situ formation of a core shell impact modifier) with an inner core of alkyl (meth)acrylate block, an outer core of elastic olefin block, and a shell of aromatic block. The shell of aromatic block is miscible with both PPE and PS.

It is unexpected that the ability to conform the tri-block copolymer within the PPE/PS dispersed regions can control the placement of the impact modification of the present invention to the only the discontinuous phase of the blends of the present invention.

Optional Additional Impact Modifier

The impact modification of blends of the invention can be altered by adding a styrenic block copolymer to the blend. Styrenic block copolymers are well known as having a styrenic end blocks and olefinic midblocks. The combination of styrenic and olefinic blocks provides a non-crosslinked thermoplastic elastomer polymer. Commercially available styrenic block copolymers are Kraton brand copolymers from Kraton Company. Among the commercial offerings are Kraton G, Kraton D, Kraton FG, Kraton FD, and Kraton A copolymers.

Such styrenic block copolymer, preferably Kraton A copolymer, can be included in the blend of the present invention in an amount from 0 to about 10, and preferably from about 5 weight percent of the blend.

Optional Additives

As with many thermoplastic compounds, it is optional and desirable to include other additives to improve processing or performance. Non-limiting examples of such optional additives include slip agents, anti-blocking agents, antioxidants, ultraviolet light stabilizers, quenchers, dyes and pigments, plasticizers, mold release agents, lubricants, antistatic agents, fire retardants, and fillers such as glass fibers, talc, chalk, or clay. Of these fillers, the properties of nanoclay can add stiffness, toughness, and charring properties for flame retardancy.

Additionally compatibilizing additives such as maleic anhydride, citric acid, fumaric acid, itaconic acid, etc. can be added to the blend to enhance compatibilization and can be used with non-functionalized PPE.

Such optional additives, filler, and fibers can be included in the blend of the present invention in an amount from about 0 to about 40, and preferably from about 0.1 to about 20 weight percent. Most preferably, the amount is about 1 to about 5 weight percent of the blend.

Method of Processing Blends

The blend of the present invention can be prepared by any method which makes it possible to produce a thoroughly mixed blend containing polyamide, PPE/PS blend, the triblock copolymer impact modifier, optional other polymers and impact modifiers described above, and other optional additives, if any. It is possible, for example, to dry-mix the ingredients constituting the compound, then to extrude the resulting mixture and to reduce the extrudate to pellets.

As an example, extrusion can be carried out in a suitable extruder, such as a Wemer-Pfleiderer co-rotating twin screw extruder. The extruder should be capable of screw speeds ranging from about 50 to about 12,000 rpm. The temperature profile from the barrel number two to the die should range from about 170° C. to about 300° C., and preferably from about 250° C. to about 285° C., depending on the ingredients of the melt. The extruder can be fed separately with the ingredients of the blend or together.

The selected temperature range should be from about 200° C. to about 285° C. The extrudate can be pelletized or directed into a profile die. If pelletized, the pellets can then be molded by injection, compression, or blow molding techniques known to those skilled in the art.

It is unexpected that all of the ingredients introduced into the main throat and melted in the extruder find their respective, proper locations at the final blend morphology: PA as matrix, within which there are dispersed domains of PPE/PS, within which there are dispersed simulate core-shell particles of tri-block copolymer (as theorized above). Moreover, the compatibilizing polymer reacts with the PA and affiliates with the PPE or PS at the interface of the PPE/PS-PA (discontinuous/continuous interface). For example, see FIGS. 1 and 2 described in greater detail below.

Usefulness of the Invention

Impact-modified thermoplastic polymer blends of the present invention can be used alone (compound) or in combination with other resins, fillers, etc. (a concentrate to be intermixed (“let down”)) to make a variety of molded or extruded articles. For example, these blends are useful for transportation-related molded items (e.g., crash helmets and parts for vehicles such as bumpers and fenders); electrical equipment when flame retardants or reinforcing fillers are also added (e.g., plugs, connectors, boxes, and switches); and consumer appliance housings and containers (e.g., kitchen appliance housings and shells, and consumer electronics housings and cases).

Further embodiments of the invention are described in the following Examples.

### EXAMPLES

### Test Methods

Table 1 shows the test methods used in conjunction with the evaluation of the examples.

TABLE 1

| Test Name | Test Method |
|---|---|
| Melt Flow Index (MFI) | ASTM D1238 |
| Melt Viscosity Rate (MVR) | ASTM D1238 |
| Tensile Strength | ASTM D638 |
| Elongation Modulus | ASTM D638 |
| % Elongation at Break | ASTM D638 Rigid |
| Notched Charpy Impact Strength | ASTM D256 |
| Unnotched Charpy Impact Strength | ASTM D256 |

Blend Ingredients and Order of Addition

Table 2 shows the ingredients of Examples 1 and 2. Table 3 shows the order of delivery to a Werner-Pfleiderer ZSK-70 co-rotating twin-screw extruder operating above melt temperature and 250-350 rpm speed. The extrudate was pelletized and subsequently injection molded into the various required test forms on an Arburg injection molding machine operating at 250° C. to 260° C. (T-melt).

TABLE 2
Ingredients

| Ingredient | Chemical | Purpose | Source |
|---|---|---|---|
| 145 PA66 | Polyamide | Polymer base | Rhodia |
| Noryl 6390 H - PPE | PPE/HIPS | Polymer Base | General Electric |
| SBM AF-X223 | Triblock copolymer | Impact Modifier | ATOFina |
| FAPPE | Fumaric Acid grafted PPE | Compatibilizer | DH Compounding |
| Irganox 1010 | Phenolic | Antioxidant | CIBA |
| Ultranox 626 | Phosphite | Stabilizer | Crompton |
| Steamic | Talc | Nucleator | Luzenac |
| H160 | Phenolic | Antioxidant | Brüggemann |
| EP32 | Wax ester | Lubricant | Cognis |
| Kraton A RP6935 | Styrenic Block Copolymer | Impact Modifier | Kraton |
| Kraton FG 1901 x | Styrenic Block Anhydride | Impact Modifier | Kraton |
| | Functionalized Copolymer | | |

TABLE 3
Parts By Weight

| Raw Materials | Feed Location | Example 1 | Example 2 |
|---|---|---|---|
| 145 PA66 | Main | 42 | 42 |
| Noryl 6390 H - PPO | Main or downstream | 40 | 45 |
| SBM AF-X223 | Main | 10 | 10 |
| FAPPE | Main | 3 | 3 |
| Kraton A RP6935 | Main | 5 | — |
| Polymers Subtotal | | 100 | 100 |
| Irganox 1010 | Main | 0.3 | 0.3 |
| Ultranox 626 | Main | 0.3 | 0.3 |
| Steamic | Main | 0.15 | 0.15 |
| H160 | Main | 0.3 | 0.3 |
| EP32 | Main | 0.8 | 0.8 |
| Additives Subtotal | | 1.85 | 1.85 |
| Total | | 101.85 | 101.85 |

### RESULTS

Table 4 shows the experimental results.

TABLE 4

| Properties | Example 1 | Example 2 |
|---|---|---|
| Density (g/cm³) | 1.090 | 1.095 |
| MFI* (g/10 min.) | 3.4 | 3 |
| MVR (cm³/10 min.) | 3.7 | 2 |
| Charpy Impact Unnotched (kJ/m²) | 100% No Break | 30% No Break |
| Charpy Impact Notched (kJ/m²) | 13.8 | 13** |
| Tensile Strength (MPa) | 57 | 65 |
| E Modulus (MPa) | 2300 | 2480 |
| Elongation Strain at Break (%) | 12 | 8 |

*Test Conditions 275° C./2.16 kg
**Average of 8.3 and 15.8

Table 4 shows that Examples 1 and 2 have excellent impact properties 5 while not otherwise affecting tensile properties, density, etc. typical of a PA-PPE/PS blend.

The invention is not limited to the above embodiments. The claims follow.

What is claimed is:

1. A thermoplastic polymer blend, comprising:
(a) a polyamide;
(b) a polyphenylene ether;
(c) a tri-block copolymer of an aromatic monomer, an olefin monomer, and an alkyl (meth)acrylate monomer; and
(d) a compatibilizing polymer containing a dicarboxylic acid anhydride functionality, optionally formed in-situ with a portion of the polyphenylene ether.

2. The blend of claim 1, wherein the polyphenylene ether is in a blend with polystyrene.

3. The blend of claim 2, wherein the polyamide is polyamide 6,6 and the polystyrene is high-impact polystyrene.

4. The blend of claim 3, wherein the tri-block copolymer is styrene-butadiene-methylmethacrylate.

5. The blend of claim 4, wherein the polyamide ranges from about 30 to about 50 weight percent of the blend, wherein the polyphenylene ether/polystyrene blend ranges from about 30 to about 50 weight percent of the blend.

6. The blend of claim 5, wherein the amount of triblock copolymer ranges from about 3 to about 25 weight percent of the blend.

7. The blend of claim 1, wherein the compatibilizing polymer is the in-situ reaction product of polyphenylene ether with one or more aliphatic polycarboxylic acids or derivatives thereof represented by the formula:
(R^{I}O)ₘR(COOR^{II})ₙ(CONR^{III}R^{IV})ₛ
wherein R is a linear or branched chain, saturated aliphatic hydrocarbon of from 2 to 20 carbon atoms; R^{I} is selected from the group consisting of hydrogen, and alkyl, aryl, acyl and carbonyl dioxy groups having from 1 to 10 carbon atoms; each R^{II} is independently selected from the group consisting of hydrogen, and alkyl or aryl groups having from 1 to 20 carbon atoms; each R^{III} and R^{IV} is independently selected from the group consisting of hydrogen, and alkyl or aryl groups having from 1 to 10 carbon atoms; m is equal to 1 and (n+s) is greater than or equal to 2, and n and s are each greater than or equal to 0; wherein (OR^{I}) is alpha or beta to a carbonyl group and at least 2 carbonyl groups are separated by 2 to 6 carbon atoms.

8. The blend of claim 1 , further comprising a styrenic block copolymer.

9. The blend of claim 1, further comprising optional additives selected from the group consisting of slip agents, antiblocking agents, antioxidants, ultraviolet light stabilizers, quenchers, dyes and pigments, plasticizers, mold release agents, lubricants, antistatic agents, fire retardants, fillers, and combinations thereof

10. The blend of claim 9, wherein the fillers comprise glass fibers, talc, chalk, or clay.

11. The blend of claim 10, wherein the clay is a nanoclay.

12. The blend of claim 11, wherein the clay is pre-dispersed in amide monomer before polymerization of the polyamide.

13. The blend of claim 1, wherein the polyamide comprises a continuous matrix, wherein the polystyrene comprises dispersed regions within the matrix, wherein the tri-block copolymer comprises dispersed regions within the polystyrene, and wherein the compatibilizing polymer is reacted to polyamide at interfaces between the polyamide continuous matrix and the dispersed regions of the polystyrene.

14. The blend of claim 2, wherein the polyamide comprises a continuous matrix, wherein the blend of polystyrene and polyphenylene ether comprises dispersed regions within the matrix, wherein the tri-block copolymer comprises dispersed regions within the blend of polystyrene and polyphenylene ether, and wherein the compatibilizing polymer is reacted to polyamide at interfaces between the polyamide continuous matrix and the dispersed regions of the blend of polystyrene and polyphenylene ether.

15. An article made from the blend of claim 1.

16. The article according to claim 15, wherein the polyphenylene ether is in a blend with polystyrene.

17. The article according to claim 15, wherein the article is made by extrusion or molding techniques.

18. The article according to claim 15, wherein the article is selected from the group consisting of a transportation-related item, electrical equipment, and consumer appliance housings and containers.

19. The article according to claim 16, wherein the article is made by extrusion or molding techniques.

20. The article according to claim 16, wherein the article is selected from the group consisting of a transportation-related item, electrical equipment, and consumer appliance housings and containers.
